(19) United States
(12) Patent Application Publication
(10) Pub. No.: US 2013/0177193 A1
(43) Pub. Date: Jul. 11, 2013

(54) EARBUD OR IN-EAR HEADPHONE CLIP

(71) Applicants: Stephen E. ORZEL, Hamilton (CA); Graham T. HILLS, Hamilton (CA); Kirk A. MOSNA, Ancaster (CA); David L. MACKIE, Dundas (CA)

(72) Inventors: Stephen E. ORZEL, Hamilton (CA); Graham T. HILLS, Hamilton (CA); Kirk A. MOSNA, Ancaster (CA); David L. MACKIE, Dundas (CA)

(73) Assignee: OHM INDUSTRIAL DESIGNERS, INC., Hamilton (CA)

(21) Appl. No.: 13/737,445

(22) Filed: Jan. 9, 2013

Related U.S. Application Data
(60) Provisional application No. 61/585,385, filed on Jan. 11, 2012.
(60) Provisional application No. 61/600,353, filed on Feb. 17, 2012.

(51) Int. Cl. H04R 1/10

(52) U.S. Cl. CPC H04R 1/1033
USPC 381/380; 264/250

(57) ABSTRACT

A securing device attached to an earphone that has an earbud or in-ear structure that sits in or within the vicinity of the concha cavity of the ear is disclosed. The securing device reduces the risk of dislodgement of the earphone from a wearer's ear, and also can position the earphone for optimum comfort and sound delivery to the ear canal. The invention further relates to a clip that detachably couples to earbud-style earphones for a universal fit.

### BACKGROUND OF THE INVENTION

Headphones, headsets or earphones (hereinafter referred to generally as ‘earphones’) are used by a large number of people to listen to audio from a variety of sources such as digital music players, tapes, cell phones, radios, computers, mobile media players, DVD players, portable televisions, and the like. Earphones are well-known in the prior art as an electro-acoustic transducer that offers simplicity, personal audio, and portability. An earphone is typically used with a single ear, using a single audio channel, and in this singular configuration is generally suited more for spoken audio than music. An earphone may also be used in tandem with both ears, and in which case are referred to in the plural as earphones. Headphones are generally better suited for listening to music, particularly in stereo or simulated surround sound, where more than one audio channel is used. Earphone(s) are often worn by a wearer while simultaneously doing a variety of different activities. The physical activity level that a wearer can be engaged in while wearing an earphone(s) can vary greatly, from stationary/sedentary to highly vigorous or extreme activities. Frequently, a significant range in physical activity levels may occur while listening to earphone(s) throughout a day or other time period. For example, a wearer may use earphone(s) to listen to music while relaxing and inclined, and then later while running or engaged in other exercise.

A variety of earphone designs have been developed over the years. One of the most popular is referred to as an earbud or an in-ear type earphone (hereinafter referred to as ‘earbud’, or ‘earbuds’ when in tandem for both ears). Earbuds are electro-acoustic transducer devices of a compact size designed to fit within the area of the concha and/or auditory canal of the external ear of a wearer so the wearer can listen to audio being transmitted from a sound source. Earbuds are an especially popular type of earphones to be sold as a component of a packaged system, typically where the earbuds are sold along with a variety of different audio or multimedia source devices. A particular phenomenon of this is the iPod®, iPhone® and iPad® line of digital media players, cell phones and tablet computers, respectively, produced by the Apple Computer Corporation of Cupertino, Calif. To date, over 400 million units of iPod, iPhone and iPad devise and pairs of earbud-type headphones packaged therewith have been sold worldwide.

When properly positioned in the ear, earbuds can provide the wearer with acceptable sound transmission to the ear audio canal. However, due to anatomical variation between ears of different wearers, and to a lesser extent ear-to-ear variation of a single wearer, earbuds may not fit a wearer's ears. For some wearers, earbuds may simply fall out, or easily fall out of the ears. Even a moderate increase in physical activity of a wearer will tend to exacerbate poor or marginal fit between an earbud and the wearer's ear. Additionally, movement during vigorous activity can cause even a well-fitting earbud to dislodge from the ear of a wearer resulting in distraction and annoyance to the wearer.

Earbuds that fit into the ear may be designed to remain securely confined within the concha of the outer ear structure by having a custom shape that conforms and fits closely in contact with the walls of the ear canal or the walls of the concha cavity to the ear canal. When custom fitting is not available as when universally constructed, the earbud is generally provided with a foam or conforming cover that fits over the earbud to approximate a custom fit for the ear structure of an average wearer. Alternatively, the shape of the earbud itself is custom designed to fit the ear structure of an average wearer. In the further alternative, the earbud may be provided with an attached hook or wire that fits over or around the outer ear between the head of the wearer and the outer structures of the ear (e.g. the helix, scapha), and is connected to the earbud proximate to the outer opening of the concha so as to provide means for securing the earbud inside the concha cavity.

Among different people, significant variation exists in ear shapes that must be accommodated when designing a universal fit for earbud or in-ear earphone structures. The tragus and anti-tragus are features that extend over the ear canal and generally serve to overhang a portion of the earbud structure that prevents the earbud from dislodging and falling out of the ear. Foam covers for earbuds generally facilitate greater contact between the earbud and the walls of the concha inside the concha, between the ear canal and the overhanging tragus and anti-tragus, which in turn provides additional hold for the earbud by means of friction with the concha walls.

While some custom fitted earbuds have been designed to fill the concha cavity to maximize a secure fit by contact with all concha walls, these designs are generally unattractive, and unsuitable for providing a universal fit due to variations in concha shapes among individuals. Earhooks are also unattractive, and interfere with earpieces of eyeglasses by competing for space between the top of the ear and the side of the wearer's head. An earbud or in-ear earphone can also be secured by attaching a structure the fits over the head, which is cumbersome and generally less comfortable for a wearer.

Accordingly, there is a long-felt need for a mechanism for securing earbud or in-ear earphones that overcomes the above-noted shortcomings.

### SUMMARY OF THE INVENTION

The present invention relates generally to earphones that are worn in the ears, and more particularly, to a securing device attached to or is a part of the earphone that has an earbud or in-ear structure that sits in or within the vicinity of the concha cavity of the ear. The securing device reduces the risk of dislodgement of the earphone from a wearer's ear, and also can position the earphone for optimum sound delivery to the ear canal. In a preferred embodiment, the present invention provides a clip that detachably couples to earbud-style earphones for a universal fit. The present invention is suitable for use in wired or wireless telecommunications, telephony and multimedia devices.

### BRIEF DESCRIPTION OF THE FIGURES

FIG. 1 is a diagram of the anatomy of a typical human ear.

FIG. 2 is a perspective view of a prior art earbud assembly.

FIG. 3 is a perspective, side, front and rear view of an earbud clip, in accordance with an embodiment of the present invention.

FIG. 4 is a perspective view of an earbud clip illustrating how it is coupled with a prior art earbud assembly, in accordance with an embodiment of the present invention.

FIG. 5 is a side view of an earbud clip coupled with an earbud assembly illustrating adjustment for alternate ear sizes.

FIG. 6 is a section view of an earbud clip coupled with an earbud assembly illustrating the fit within an ear of a wearer in a first configuration.

FIG. 7 is a section view of an earbud clip coupled with an earbud assembly illustrating the fit within an ear of a wearer in a second configuration.

FIG. 8 is a perspective view of an earbud clip and perspective views of the earbud clip coupled with an earbud assembly, in accordance with an embodiment of the present invention.

FIG. 9 is a perspective view of an earbud clip and perspective views of the earbud clip coupled with an earbud assembly, in accordance with an embodiment of the present invention.

FIG. 10 is a perspective view of an earbud clip and the earbud clip coupled with an earbud assembly illustrating the fit within an ear of a wearer, in accordance with an embodiment of the present invention.

FIG. 11 is a perspective view of an earbud clip and the earbud clip coupled with an earbud assembly illustrating the fit within an ear of a wearer, in accordance with an embodiment of the present invention.

FIG. 12 is a perspective view of an earbud assembly comprising sound ports.

FIG. 13 is a front perspective, side and bottom view of an earbud clip and a front perspective view of the earbud clip partially coupled with an earbud assembly, in accordance with an embodiment of the present invention.

### DETAILED DESCRIPTION OF THE INVENTION

The following description is presented to enable any person skilled in the art to make and use the invention, and is provided in the context of particular applications of the invention. Various embodiments of the present invention will be described in detail with reference to the figures, wherein like reference numerals represent like parts throughout the several views. Various modifications to the disclosed embodiments will be readily apparent to those skilled in the art, and the general principles defined herein may be applied to other embodiments and applications without departing from the scope of the present invention. Reference to various embodiments and examples does not limit the scope of the invention, which is limited only by the scope of the claims attached hereto. Additionally, any examples set forth in this specification are not intended to be limiting and merely set forth some of the many possible embodiments for the claimed invention.

Accordingly, in one aspect, the present invention provides a securing device for an earbud having a stem, said securing device comprising: an upper portion having a tip; and a lower portion adapted to accommodate the stem of the earbud, wherein the tip is adapted to rest in an ear concha under the concha wall, and wherein the securing device is detachably coupled to the earbud by inserting the stem into the lower portion. The lower portion may further comprise a groove. The securing device may further comprise a coating that covers the tip, wherein said coating is selected from the group comprising: an elastomer, a non-slip material, a low density polymer, and an adhesive material. The upper portion may comprise a flange proximate to the tip. The securing device may be at least partially constructed from a flexible material. The securing device may be at least partially constructed from an internal skeleton structure comprising a material that is more rigid than that of an encapsulating material. The end of the lower portion may comprise an end with a face, wherein the face comprises an indentation adapted to accommodate a cable inside the indentation without resulting in a bend or a kink in the cable. The lower portion may comprise a groove, wherein the groove comprises at least one recessed channel disposed inside said groove. The lower portion may comprise a friction pad disposed inside the groove. The lower portion may comprise an opening; wherein the upper portion comprises a friction pad adapted to fit through the opening.

In another aspect, the present invention provides a securing device for an earbud having a speaker housing, said securing device comprising: an upper portion having a tip; and a lower portion attached to the speaker housing, wherein the tip is adapted to rest in the ear concha under the concha wall.

In a further aspect, the present invention provides a method of manufacturing the securing device described above, wherein the method comprises a first step, wherein said first step is selected from the group comprising injection moulding at least a portion of the device with a mould, casting at least a portion of the device from a die, extruding at least a portion of the device from an extruder, and stamping at least a portion of the device with a stamp. The injection moulding step may be further selected from the group comprising: two-shot moulding the upper portion and lower portion as a single piece, and overmoulding the upper portion and lower portion as a single piece. The upper portion may comprise a friction pad, wherein the lower portion comprises an opening, and wherein the upper portion and lower portion are manufactured such that the friction pad fits through the opening.

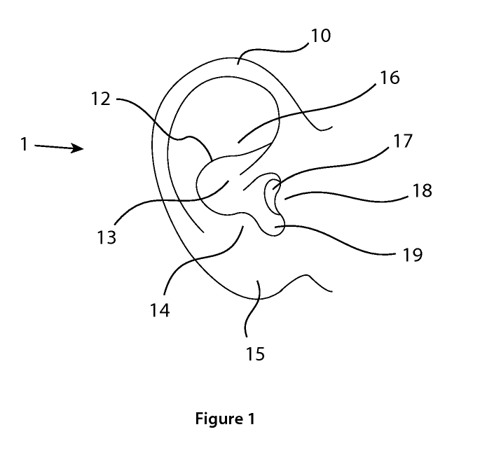

For the purposes of illustration and to assist in the understanding of the invention and its placement with respect of earbuds of the prior art, a view of a typical human ear is shown in FIG. 1. The outer ear has two general surfaces that are defined by the direction they face. There is a front-side portion that faces away from the head as shown in FIG. 1, and a backside portion that faces towards the head. The external or outer ear consists of the pinna or auricle and auditory canal 17 or meatus. The auricle is a cartilaginous member having a structure that is irregularly concave, directed slightly towards a person's anterior, and having a number of ridges and depressions. The helix 10 is the prominent external outer edge of the auricle and the antihelix 16 is contained within the outer perimeter of the helix 10. The concha 13 contains the entry to the auditory canal 17. On the anterior side, relative the greater person, and projecting backwards with a point-like eminence over the auditory canal 17 is the tragus 18. Opposite the tragus 18 is the antitragus 14, a small rounded projection. The tragus 18 and antitragus 14 are separated by the intertragic notch 19. The concha 13 is a relatively deep and spacious cavity, the outer perimeter of this cavity is generally defined around its perimeter by the conchal wall 12, antitragus 14, tragus 18, and intertragic notch 19. At the bottom of the ear, below the tragus 18 and antitragus 14, is the lobe 15.

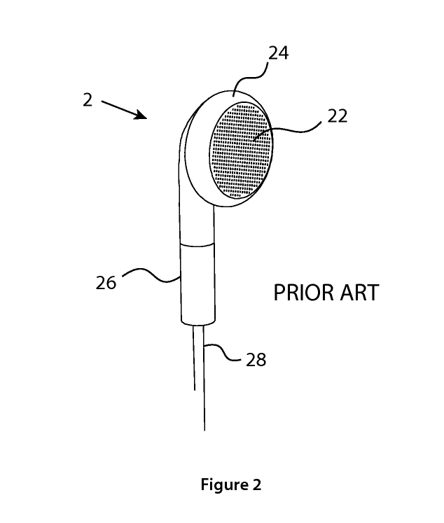

Referring to FIG. 2, a typical prior art earbud assembly 2 is shown. Two such earbud assemblies used in tandem would together form a set of earbuds, connected by a common cable (not shown), for use in each ear at the same time. This common cable would typically comprise, inter alia, a plug adapted to be connected to a receptacle in an audio source device, a cable 28 (also known as cord) having a predetermined length, and the earbud 2. In the case of stereo earbuds, the cable 28 can bifurcate at some point along its length (not shown) and each respective cable section can then attach to the right or left earbud 2. It should be noted that earbuds can also be wireless, in which case, the cable 28 is not present. A common type of earbud 2, as shown in this example, consists of a speaker housing 24 and a stem 26 which extends from or attaches to the speaker housing 24, the stem contains cable 28 for the speaker and the cable exits the stem 26 at its end. The bottom of the speaker housing 24 may optionally have a speaker grate 22. Earbuds are generally worn within the concha 13 and/or auditory canal 17 of the ear of a wearer. When worn, the earbud speaker housing 24 is typically supported by the tragus 18, antitragus 14, concha 13 and/or auditory canal 17. The earbud 2 is typically oriented so the stem 26 is pointed roughly downward and the stem 26 is typically positioned in the area of the intertragic notch 19. With the stem 26 positioned in the area of the intertragic notch 19, the stem 26 is generally constrained on either side by the antitragus 14 and tragus 18 both of which protrude outward relative to the intertragic notch 19.

As shown in FIG. 2, the earbud speaker housing 24 outer perimeter is commonly generally circular in its outer profile. When worn in the typical manner, the outer perimeter of the housing of the earbud is constrained by the concha 13 cavity and/or the auditory canal 17 in which the earbud speaker fits, and more particularly, can be constrained by the space available in the conchal area between the conchal wall 12, antitragus 14, and tragus 18. The bottom of the earbud speaker housing can consist of a speaker surface or grate 22. The surface of the grate 22 portion of the earbud generally rests at the bottom of the concha 13 and typically covers or extends into a portion of the auditory canal 17. An earbud stem 26, is typically an elongated cylindrical structure having a predetermined length, the stem typically extends from or attaches to the speaker housing 24 at an angle therefrom. Other shapes for the cross-section of the stem 26 other than a circle are also common such as oval, triangular, square, or other cross-sectional shape profile. The cross-sectional shape of the stem 26 can also vary in cross-sectional shape along the stem's elongated length from any combination of different shapes. The stem 26 may also follow a trajectory along its length that is straight or that has one or more curves and/or changes. The stem 26 is a common but optional feature of an earbud 2, if the stem 26 is not present then the cable 28 can extend directly from the speaker housing. Canal phones are another type of prior art headphone that are closely related in design to earbuds. Canal phones can have an extending structure (not shown) that extends at least partially into the auditory canal 17. The structure of canal phones to that of earbuds may otherwise be similar. The claimed invention relates to both earbuds and canal phones. As used herein, the term earbud or earbuds refers generically to both earbuds and canal phones.

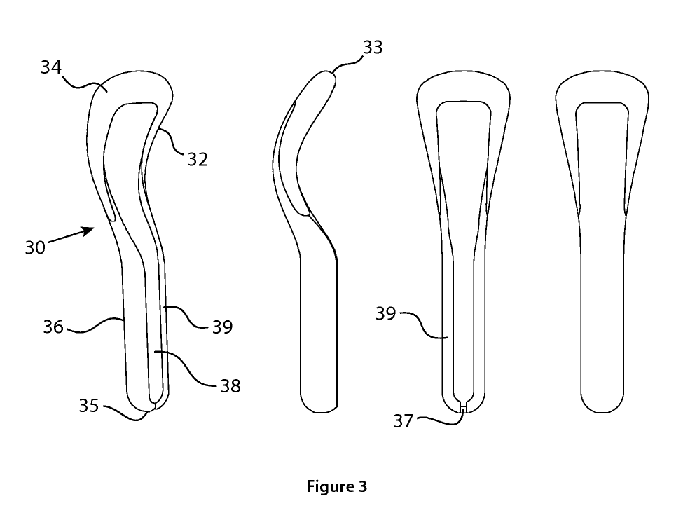

Referring to FIG. 3, four views are shown of one embodiment of an earbud securing device 30 of the present invention. Specifically, a first perspective view is shown, along with side, front and back views of the device, or clip 30. The clip 30 generally comprises two sections, an upper portion 32, and a lower portion 36. Upper portion 32 ends at a tip 33 that is generally shaped to rest comfortably in the ear concha 13, and under the concha wall 12. Lower portion 36 is generally shaped by sidewalls 39 to provide an open channel or groove 38 having an interior cross-sectional dimension that is equal to or narrower than the exterior cross-sectional dimension of stem 26 of earbud 2, so as to be able to accommodate stem 26 within groove 38. Optionally, a notch or indentation 37 is provided at a flanged end 35 of lower portion 36, and has an interior dimension greater than the circumference of cable 38. Alternatively, the groove 38 in lower portion 36 can be open at its end 35 (not shown). In a further alternative, in place of groove 38, the lower portion can consist of a generally cylindrical structure with an open, non-flanged end (not shown) that is adapted to accommodate the shape of earbud stem 26.

Optionally, clip 30 may comprise a coating 34 that covers tip 33 and that may also cover some or all of upper portion 32. The coating 32 may be provided as an elastomer or other suitable material to form a surface that enhances the friction of the tip 33 when pressed against the skin of the concha 13 and concha wall 12 of a wearer's ear 1. In a further alternative, some of or the entire upper portion 32 may be made from a flexible elastomer or similar material, such that upper portion 32 provides flex to improve wearer fit and comfort. As would be appreciated by one skilled in the art, other variations in materials can be incorporated such as an inner skeleton construction with a more rigid structure (e.g. metal, higher density polymer, and the like) that is partially or fully encapsulated by a softer material (e.g. elastomer or lower density polymer, and the like). The structure of the inner skeleton can also be adjusted to allow the properties to be tailored for different areas of the present invention. Alternatively, certain component can be of a more rigid material, such as the lower portion 36 so that the clip 30 can provide a more secure grip on earbud stem 26.

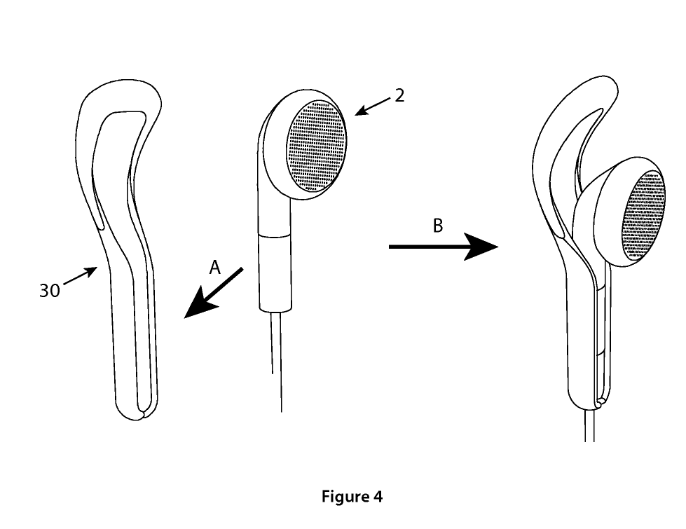

Referring to FIG. 4, clip 30 is removably attached to earbud 2 by pushing the earbud stem 26 into the channel or groove 38, as shown by arrow A. Earbud 2 is slid in or snapped securely into groove 38 of clip 30. As shown by arrow B, inserted earbud 2 into clip 30 securely couples the two devices into a single unit. In the instance where the lower portion 36 is in the form of cylinder without groove 38 (not shown), lower portion would fit like a sleeve over earbud stem 26. As shown by the clip 30 attached to earbud 2 in FIG. 4, indentation 37 allows cable 38 to exit at the end 35 of lower portion 36 without causing a kink or twist in the cable.

As noted above, earbud stem 26 can be in an elongated and generally cylindrical structure, with various shapes for the cross-section of the stem 26, such as a circle, oval, triangle, square, or other cross-sectional shape profile, and can also vary in cross-sectional shape along the stem's elongated length from any combination of different shapes. The stem 26 may also follow a trajectory along its length that is straight or that has one or more curves and/or changes. As would be readily understood by a person skilled in the art, lower portion 36 can be adapted to match different earbud stems structures.

In another embodiment, not shown, the clip 30 may be attached to earbud stem 26 by a permanent means either during manufacture of earbud 2, or subsequently attached by an adhesive or other suitable attachment means. Also, for earbud designs that lack a stem structure, clip 30 may be affixed directly to the speaker housing 24.

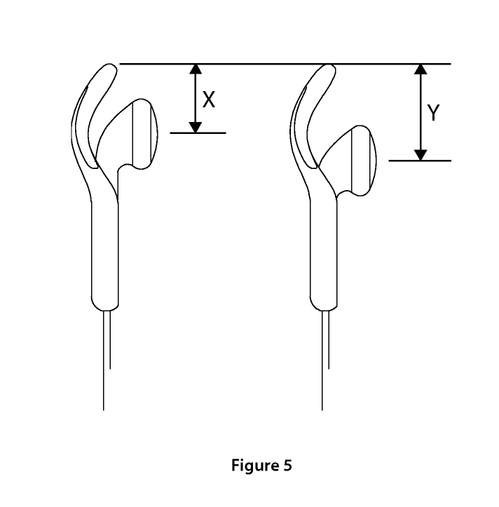

Referring to FIG. 5, earbud 2 and clip 30 are shown as coupled in two different positions, among the wide range of positions possible, at different distances along the length of stem 26. Dimensions X and Y show two example distances between the tip 33 and mid-point of earbud speaker housing 24 at two attachment positions for wearers with smaller and larger ear sizes, respectively. Accordingly, clip 30 can be attached to earbud 2 to exactly fit the distance between the concha wall 12 and the space that holds earbud 2 (as defined by the space between the tragus 18, antitragus 14, concha 13 and/or auditory canal 17) for each ear of an individual wearer.

As discussed above, prior art design positions the earbud 2 within the wearer's ear, which is held in place between the tragus 18, antitragus 14 and the intertagic notch 19. However, the size of the tragus 18 and antitragus 14, as well as the space between them varies widely from one individual wearer to the next. Prior art earbuds utilize the undercut and friction of the tragus 18, antitragus 14 and the intertragic notch 19 as the sole means of holding the earbud in place for all wearers.

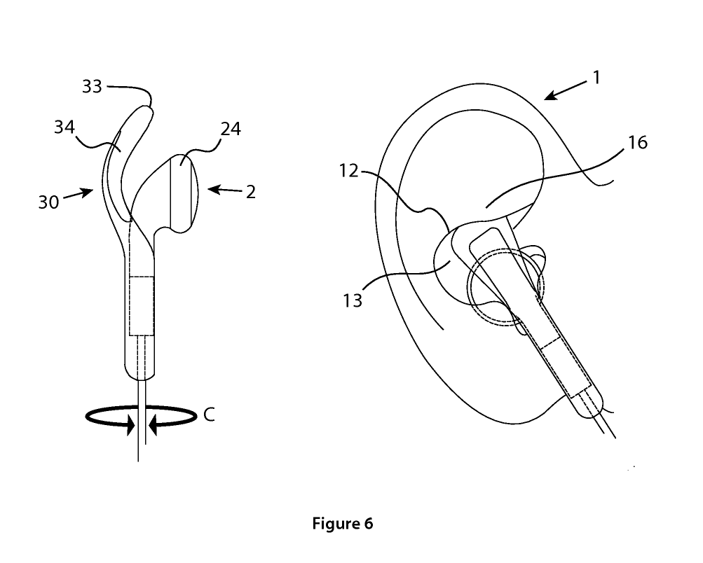

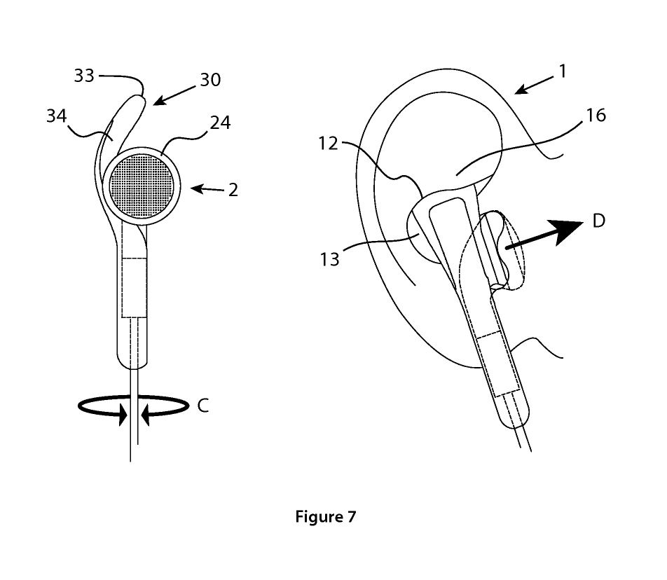

Referring to FIG. 6 and FIG. 7, clip 30 of the present invention works in unison with the prior art by adding an additional point of attachment with tip 33 against the concha wall 12, which hooks under the overhang of the antihelix 16. Clip 30 provides a light compressive force that pushes upwards on the upper concha roof underneath antihelix 16 and a downward force on the lower floor of the concha 13. The compressive force provides a more secure hold for the earbud 2, and effectively prevents dislodgement. The optional coating 34 on tip 33 is provided to add wearer comfort as well as additional friction against the upper concha roof underneath antihelix 16, further securing earbud 2 while in use.

As shown in FIG. 6, earbud speaker housing 24 is positioned such that speaker surface 22 is generally parallel to the front of the clip 30. The clip 30 can be rotated axially about stem 26, as shown by arrow C, in order to establish a highly customized fit for a variety of ear shapes and sizes.

Referring to FIG. 7, the earbud speaker housing 24 is shown rotated such that the speaker surface 22 is at about a 90° angle to the front of the clip 30. This position allows the earbud speaker to direct sound directly into the auditory canal 17, as shown by arrow D, and surprisingly results in the earbud speaker delivering noticeably louder and clearer sound than when using the earbud 2 without the clip 30. Accordingly, it can be appreciated from FIG. 6 and FIG. 7 that when attaching clip 30 to earbud 2, the wearer can rotate the earbud speaker housing 24 relative to the clip 30 to a precise angle preferred by the wearer to optimize both sound delivery and wearer comfort.

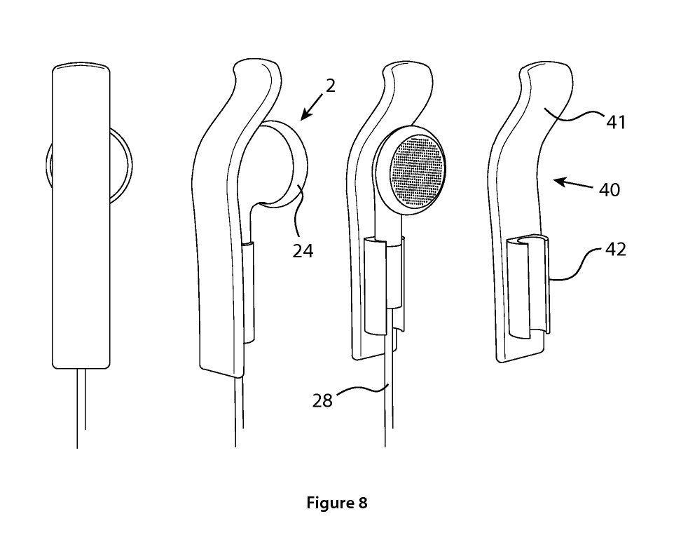

Referring to FIG. 8, an embodiment of the present invention is shown as clip 40, which differs in that clip 40 comprises a two-piece construction, comprising a first component 41 and a second component 42. As would be readily understood by a person skilled in the art, the present invention can be manufactured with one or more components for ease of construction and design. This allows, for example, ease of incorporating different materials for the different components, such as a combination of flexible and rigid materials referred to above.

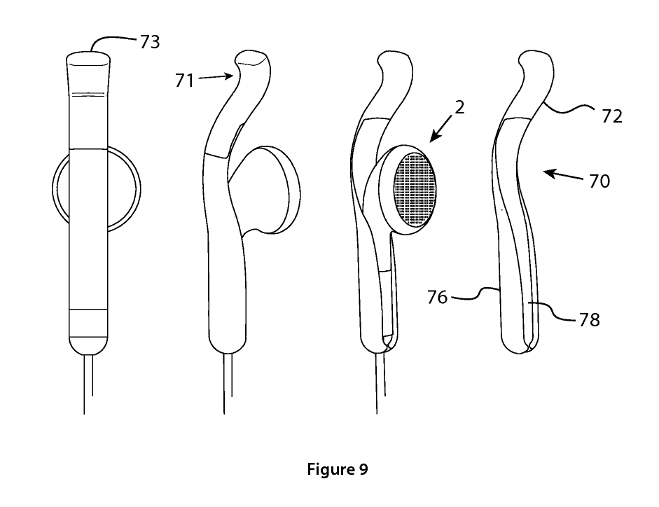

Referring to FIG. 9, a further embodiment of the present invention is shown as clip 70, which differs in that clip 70 comprises a flange or curved lip 71 proximate to the tip 73. The curved lip 71 further assists in securing clip 70 against and under the upper portion of the conchal wall 12, beneath the antihelix 16 of the wearer's ear 1. Advantageously, and further optionally, providing upper portion 72 as an elastomer or flexible material allows slight flex at the tip 73, and, surprisingly, a better fit for a wider range of wearer ear sizes without requiring the wearer to finely adjust the attachment position of the earbud stem 26 in channel 78 of the lower portion 76 of clip 70. Optionally, upper portion 72 may be provided with a smaller cross-sectional dimension, thereby allowing a greater amount of flex at the tip 73.

Also shown in FIG. 8 and FIG. 9, the clip may be provided such that earbud 2 is attached at an offset from the centre axis of the earbud stem 26 for yet a better fit in the wearer's ear 1.

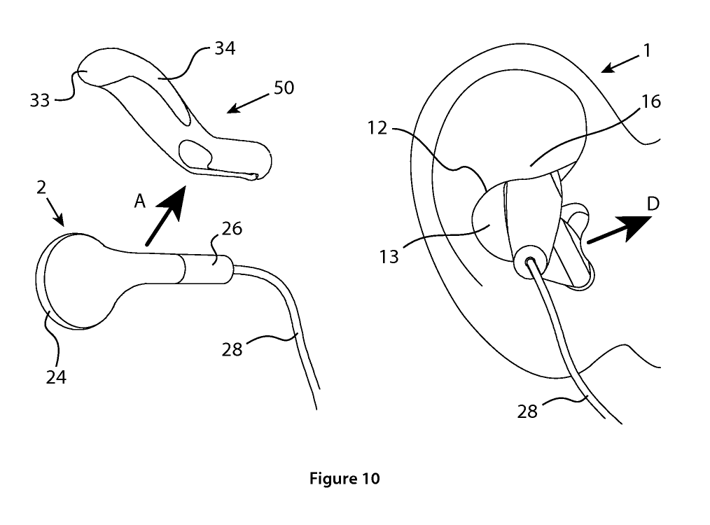

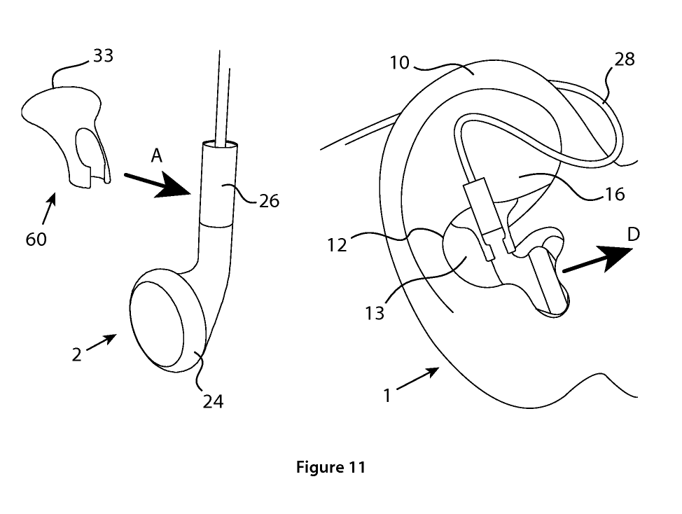

Referring to FIG. 10, a further embodiment of the present invention is shown as clip 50, which differs in that the stem 26 and cable 28 of the earbud 2 is held away perpendicular from the wearer's ear. Referring to FIG. 11, yet another embodiment of the present invention is shown as clip 60, which differs again in that the earbud stem 26 is held in an upside-down position such that cable 28 is easily hooked around and behind the helix 10 of the ear 1. As would be apparent to one skilled in the art, such alternate clip designs can be advantageous for wearers depending on their individual preference and comfort.

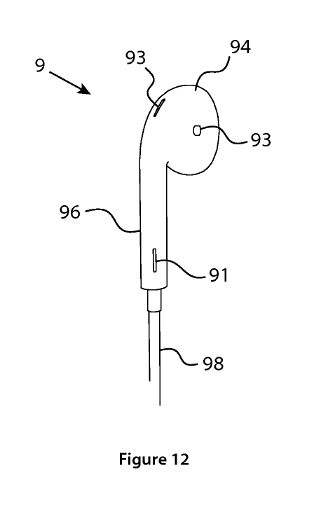

Referring to FIG. 12, a variation on a typical earbud assembly 9 is shown. Earbud assembly 9 is similar to earbud assembly 2 in most respects (e.g. it may comprise a cable or cord 98, although it could also be wireless, in which case, cable 98 would not be present; the fit when worn inside a wearer's ear 1 is similar). Similarly, earbud 9, as shown in this example, consists of a speaker housing 94 and a stem 96 which extends from or attaches to the speaker housing 94. The stem 96 contains cable 98 for the speaker and the cable exits the stem 96 at its end.

As shown in FIG. 12, earbud assembly 9 comprises additional features 91, 93 in the form of sound vents or sound ports, which are openings provided in speaker housing 94 or stem 96 to allow air flow to/from the inside of speaker housing 94 for improved sound performance of the earbud. While any number of sound ports may be provided in either speaker housing 94 or stem 96, in the example shown, sound ports 93 are disposed on the back and side of speaker housing 94, and sound port 91 is disposed on the stem 96. Additional sound ports may be provided, for example, on the opposite side of speaker housing 94 (not shown) or on stem 96, diametrically opposed to sound port 91 (not shown).

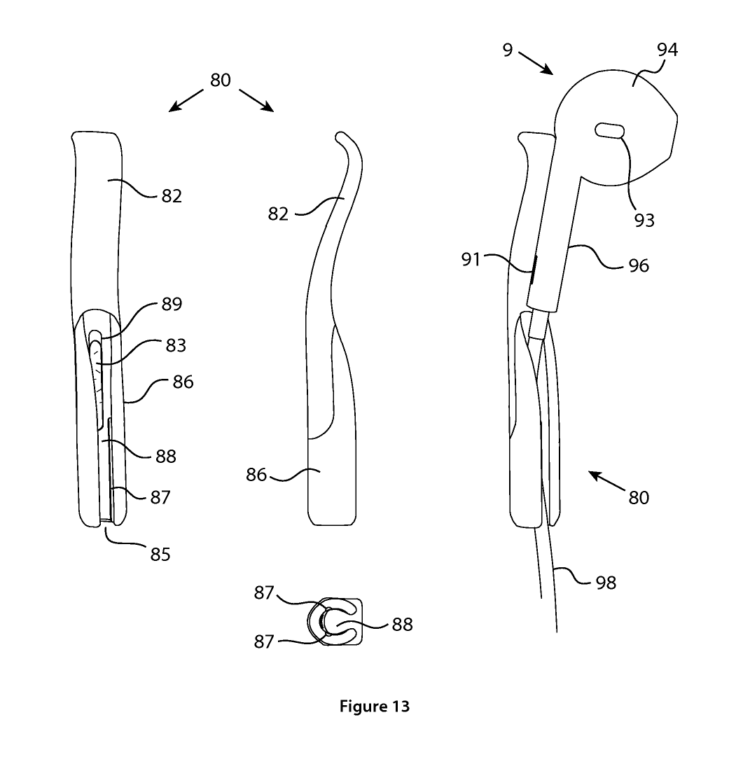

To accommodate sound ports 91, 93, a further embodiment of the present invention is shown in FIG. 13 as clip 80, which differs from clip 70 in that clip 80 comprises one or more recessed channels 87 disposed inside groove 88. Recessed channels 87 extend a predetermined length in groove 88 in a generally longitudinal manner from end 85, and generally correspond to the location of sound ports 91 on stem 96. Recessed channels 87 extend from end 85 sufficiently in length not to block the openings of sound ports 91 when earbud assembly 9 is inserted into clip 80 as shown, whereby sounds ports 91 can ‘breathe’ out end 85 via recessed channels 87 once earbud 9 is fully inserted into clip 80 (not shown).

Advantageously, and further optionally, a friction pad 83 may be provided inside groove 88 to provide a more secure fit with earbud assembly 9 by providing contact pressure against stem 96. Preferably, friction pad 83 is an elastomer or material with a suitably higher surface friction than the material of lower portion 86. Further preferably, the friction pad 83 may comprise part of upper portion 82 (e.g. elastomer moulded from a single piece), such that friction pad 83 fits within or protrudes through optional opening 89 in lower portion 86. This has the further advantage of simplifying manufacture of the clip, thereby reducing cost.

In the further alternative, the upper and lower portions may be moulded as a single piece, for example by overmoulding or two-shot moulding, to further reduce manufacturing cost. The friction pad may fit such that it is flush with the inner surface of groove 88, or it may protrude past the inner surface to provide additional frictional force.

1. A securing device for an earbud having a stem, said securing device comprising:
an upper portion having a tip; and
a lower portion adapted to accommodate the stem of the earbud,
wherein the tip is adapted to rest in an ear concha under the concha wall, and
wherein the securing device is detachably coupled to the earbud by inserting the stem into the lower portion.

2. The device of claim 1, wherein the lower portion comprises a groove.

3. The device of claim 1, wherein the securing device further comprises a coating that covers the tip, wherein said coating is selected from the group comprising: an elastomer, a non-slip material, a low density polymer, and an adhesive material.

4. The device of claim 1, wherein the securing device is at least partially constructed from a flexible material.

5. The device of claim 1, wherein the upper portion comprises a flange proximate to the tip.

6. The device of claim 1, wherein the securing device is at least partially constructed from an internal skeleton structure comprising a material that is more rigid than that of an encapsulating material.

7. The device of claim 1, wherein the end of the lower portion comprises an end with a face, and wherein the face comprises an indentation adapted to accommodate a cable inside the indentation without resulting in a bend or a kink in the cable.

8. The device of claim 1, wherein the lower portion comprises a groove, and wherein the groove comprises at least one recessed channel disposed inside said groove.

9. The device of claim 1, wherein the lower portion comprises a groove, and wherein the lower portion comprises a friction pad disposed inside the groove.

10. The device of claim 1, wherein the lower portion comprises an opening; wherein the upper portion comprises a friction pad adapted to fit through the opening.

11. A securing device for an earbud having a speaker housing, said securing device comprising:
an upper portion having a tip; and
a lower portion attached to the speaker housing,
wherein the tip is adapted to rest in the ear concha under the concha wall.

12. A method of manufacturing the securing device of claim 1, wherein the method comprises a first step, wherein said first step is selected from the group comprising injection moulding at least a portion of the device with a mould, casting at least a portion of the device from a die, extruding at least a portion of the device from an extruder, and stamping at least a portion of the device with a stamp.

13. (canceled)

14. (canceled)
